(19) United States
(12) Patent Application Publication
(10) Pub. No.: US 2013/0232109 A1
(43) Pub. Date: Sep. 5, 2013

(54) METHODS AND SYSTEMS FOR PERFORMING THREE-WAY MERGE OF MODELS

(71) Applicant: Tad Alan DEFFLER, Boonton, NJ (US)

(72) Inventor: Tad Alan DEFFLER, Boonton, NJ (US)

(73) Assignee: COMPUTER ASSOCIATES THINK, INC., Islandia, NY (US)

(21) Appl. No.: 13/412,253

(22) Filed: Mar. 5, 2012

(51) Int. Cl. G06F 17/30

(52) U.S. Cl. 707/616; 707/E17.005

(57) ABSTRACT

A method for implementing data model management at a first client application including: receiving a data model from a repository; generating a first delta from changes made to the data model; detecting whether a second delta, which is generated by a second client application from changes made to the data model at the second client application, is stored in the repository; and sending the generated first delta to the repository when the second delta is not stored in the repository. When the second delta is stored in the repository, the method includes steps of requesting the second delta generated by the second client application from the repository; generating a merged delta by merging the first delta with the second delta; and sending the merged delta to the repository. A system for implementing the data model management method.

### BACKGROUND OF THE INVENTION

1. Field of the Invention

The present invention relates generally to data modeling. In particular, the present invention relates to systems and methods for performing three-way merging of data models.

2. Description of Related Art

As the amount of digitally stored information has increased over the years, the systems and methods available for managing such information also have increased. It is not uncommon for individuals, and to a greater extent, corporations to amass hundreds, thousands, or even millions of documents, songs, spreadsheets, or other files. This information may be organized and managed in a data model stored in a repository, which can be accessed and modified by one or more users. Such repositories may have version control capabilities that allow multiple, simultaneous check outs of data models.

During the course of managing such a data model, a first user and a second user may check out and perform concurrently one or more independent and conflicting actions on the same data model. For example, the first user may modify the data model by deleting a file. The first user then may check the modified data model back into the repository. The second user, however, may rename the same file deleted by the first user. Because of these conflicting changes made by the first and second users in this example, the modified data models of the first and the second users cannot be merged in the repository simply by merging the image of the previously-saved data model of the first user with the image of the later-saved data model of the second user according to externally-determined rules. Rather, the changes made in the later-saved data model of the second user must be scripted against the image of the previously-saved data model of the first user. Thus, the merging process requires the loading of the previously-saved image of the data model of the first user from the repository to the second user. Due to the large size of the data model image, the loading process from the repository to the second user may take a significant amount time and may delay the merging process.

### SUMMARY OF THE INVENTION

Technical advantages of the invention include that, during the merging process, the repository may send a collection of changes, e.g., a delta, made by the first user to the second user, without sending the entire image of the data model. The second user may utilize a transaction manger to re-produce a copy of the data model originally downloaded from the repository. Because the entire image of the data model is not loaded from the repository to the second user, less time is needed to load the data model to the second user and the delay in the merging process may be reduced significantly.

According to an embodiment of the invention, a method for implementing data model management at a first client application may comprise the steps of: receiving a data model from a repository; generating a first delta from changes made to the data model; detecting whether a second delta, which is generated by a second client application from changes made to the data model at the second client application, is stored in the repository; sending the generated first delta to the repository when the second delta is not stored in the repository; when the second delta is stored in the repository: requesting the second delta generated by the second client application from the repository; generating a merged delta by merging the first delta with the second delta; and sending the merged delta to the repository.

According to another embodiment of the invention, a method for implementing data model management at a data model repository may comprise the steps of: storing a data model; sending the data model to a first client and a second client; receiving and storing a first delta generated from changes made by the first client to the data model; receiving a request from the second client for the first delta; sending the first delta generated by the first client to the second client; and receiving and storing a merged delta incorporating the first delta and a second delta generated by the second client from the second client.

According to still another embodiment of the invention, a system for implementing data model management may comprise a repository configured to store a data model; and a first client terminal having a first client application stored thereon that comprises computer-readable instructions instructing the first client terminal to execute steps of: receiving the data model from a repository; generating a first delta from changes made to the data model; detecting whether a second delta, which is generated from a second client terminal by making changes to the data model using a second client application implemented on the second client terminal, is stored in the repository; sending the generated first delta to the repository when the second delta is not stored in the repository; when the second delta is stored in the repository: requesting the second delta generated by the second client application from the repository; generating a merged delta by merging the first delta with the second delta; and sending the merged delta to the repository, wherein the repository is configured to execute steps of: sending the data model to the first client application and the second client application; receiving and storing the first delta generated from changes made by the first client application to the data model; receiving a request from the second client application for the first delta; sending the first delta generated by the first client application to the second client application; and receiving and storing a merged delta incorporating the first delta and the second delta generated by the second client from the second client.

Other objects, features, and advantages of an embodiment of the invention will be apparent to persons of ordinary skill in the art from the following description of an embodiment with reference to the accompanying drawings.

### BRIEF DESCRIPTION OF THE DRAWINGS

For a more complete understanding of the present invention, needs satisfied thereby, and the objects, features, and advantages thereof, reference now is made to the following descriptions taken in connection with the accompanying drawings.

FIG. 1 is a diagram depicting a data model management system according to an embodiment of the invention.

FIG. 2 is another diagram depicting a conflict to be resolved in a data model management system according to an embodiment of the invention.

FIG. 3 is a flowchart depicting a saving process for the data model management system according to an embodiment of the invention.

### DETAILED DESCRIPTION OF EMBODIMENTS OF THE INVENTION

For a more complete understanding of the present invention, needs satisfied thereby, and the objects, features, and advantages thereof, reference now is made to the following description taken in connection with the accompanying drawings.

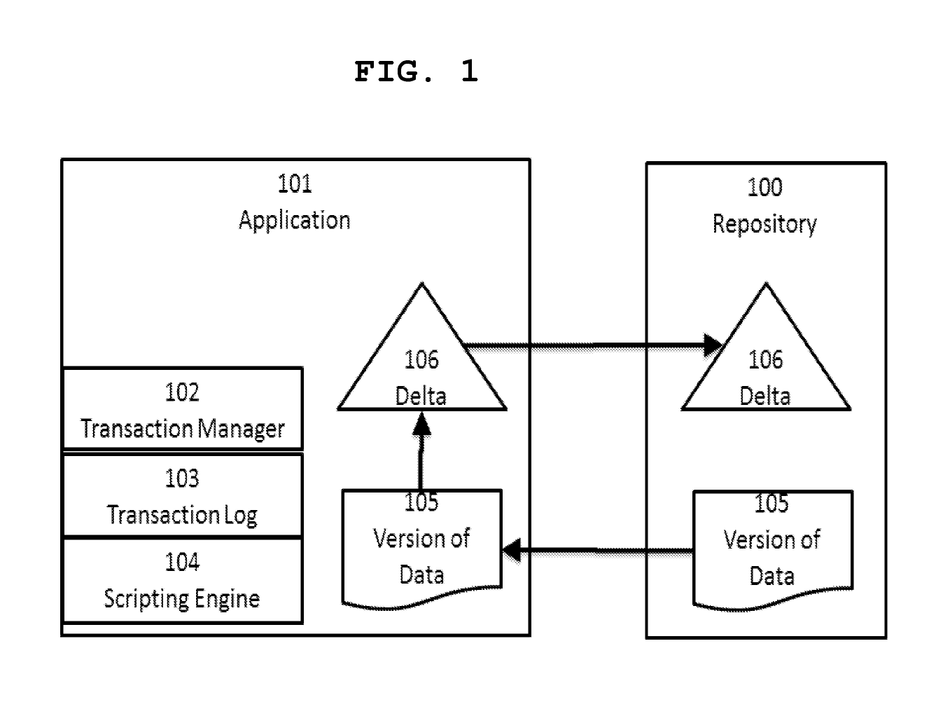

Referring to FIG. 1, a data model management system may include a repository 100 and an application 101. Repository 100 may store data models. Repository 100 may be a data server. Repository 100 may have version control capabilities and may store different versions of the same data model. Repository 100 may allow multiple and simultaneous checkouts of the same data model. Repository 100 may store the data models as atomic images, in order to speed up the process of loading the data models to and from repository 100. In another embodiment, repository 100 may store the data models as a series of deltas or reverse deltas that may be overlaid to form a final image of a data model. A delta may be a collection of changes made to the data model. A reverse delta may be a collection of changes arranged in a reverse chronological order.

Application 101 may be implemented on a computer terminal connected to repository 100 through a network. Application 101 may receive instructions from a user for implementing data model management. Application 101 may implement data model management based on the instructions received from the user. Application 101 may include a transaction manager 102, a transaction log 103, and a scripting engine 104.

Transaction manger 102 may manage transactions implemented in application 101. Transaction manager 102 may record and store transactions implemented in application 101 in transaction log 103. For example, when application 101 makes changes to a data model, transaction manager 102 may record these changes in transaction log 103. Application 101 may make changes to the data model by using scripting engine 104. Transaction manager 102 may have undo and redo functions. For example, transaction manager 102 may use scripting engine 104 to perform an undo process to undo, e.g., roll back, the changes made to the data model by referencing transaction log 103. Transaction manager 102 also may use scripting engine 104 to perform a redo process to redo, e.g., roll forward, the changes previously made to the data model. Transaction manger 102 may be robust and may allow application 101 to perform unlimited number of undo or redo processes.

A user may perform data management by using application 101. Application 101 may retrieve a data model from repository 100 based on instructions from the user. For example, application 101 may request a version of data model 105 from repository 100. Upon receiving the request from application 101, repository 100 may send a version of data model 105 to the computer terminal on which application 101 is implemented.

Application 101 may load the version of data model 105 and may provide the user with access to the version of data model 105 by displaying the version of data model 105 in a user interface, such as a graphical interface displayed on a screen or the like. The user may view and may make changes to the version of data model 105 using application 101. In particular, application 101 may receive instructions from the user to make changes to data the version of data model 105. Application 101 may generate a collection of changes, e.g., a delta 106, to the version of data model 105. Transaction manager 102 may record the collection of changes in transaction log 103. When the user finish making changes to the version of data model 105, application 101 may load the collection of changes, e.g., delta 106, to repository 100. Repository 100 may load and store delta 106 received from application 101.

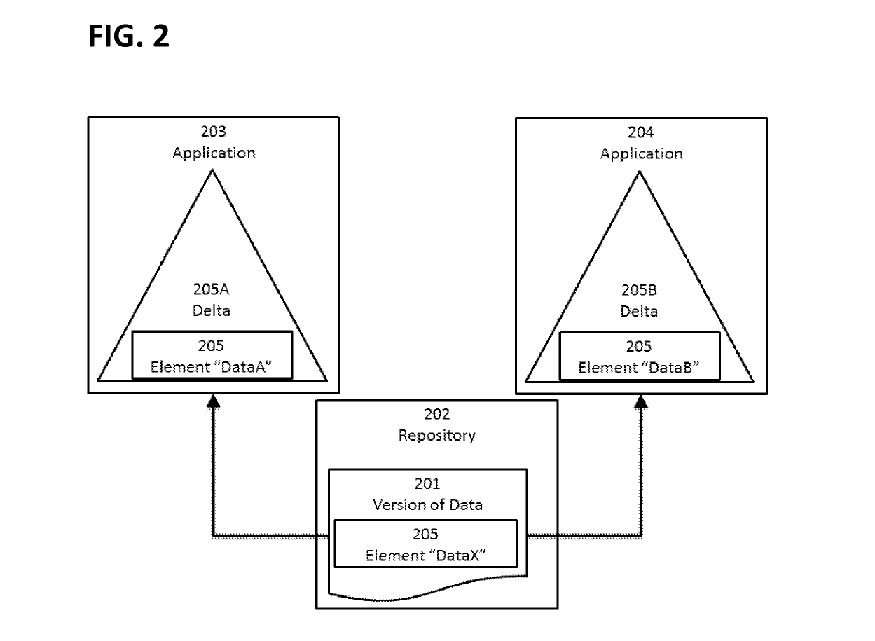

Referring to FIG. 2, a repository 202 may store a version of a data model 201. Repository 202 may have substantially similar functions to the ones of repository 100. Data model 201 may include an element named “Data X.” Repository 202 may have version control capabilities. Thus, data model 201 stored in repository 202 may simultaneously be checked out from repository 202 and modified by two or more users. For example, a first user may implement an application 203 to check out the version of data model 201 from repository 202. Repository 202 may send a first image of data model 201 to application 203. Application 203 may have substantially similar functions and components as application 101. A second user may implement application 204 concurrently to check out the same version of data model 201 from repository 202. Repository 202 may send the first image of data model 201 to application 204. Application 204 may have substantially similar functions and components as application 101.

The first user may make changes to data model 201 using application 203. For example, the first user may instruct application 203 to change the name of element 205 from “Data X” to “Data A.” Application 203 may make a collection of changes, e.g., a delta 205A, to data model 201 based on the user's instructions. Delta 205A may include the name change to element 205.

On the other hand, the second user may make changes to data model 201 by changing the name of element 205 from “Data X” to “Data B.” Application 204 may make a collection of changes, e.g., a delta 205B, to data model 201. Delta 205B also may include a different name change to element 205. Both the first user and the second user may believe that their changes are preserved. Nevertheless, because element 205 cannot be named as both “Data A” and “Data B,” a conflict occurs between the changes made to element 205 by the first user and those made by the second user.

According to an embodiment of the invention, the conflict between the changes made by the first user and the second user may be resolved by the following process. As noted above, the version of data model 201, e.g., the first image of data model 201, may be checked out from repository 202 and modified by the first and second users, concurrently. The first user may finish making changes to data model 201 before the second user and may check data model 201 back into repository 202 before the second user.

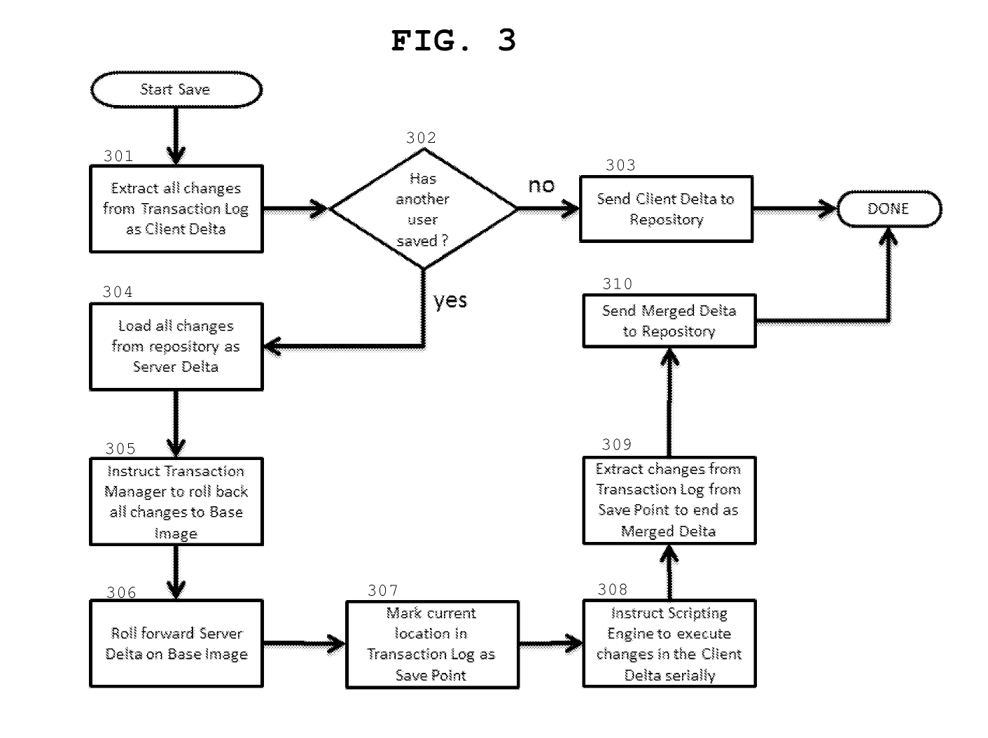

Referring to FIG. 3, during the check-in process, e.g., a saving process, at Step 301, application 203 may extract from a transaction log of application 203 all changes made by the first user which are recorded in the transaction log of application 203. Application 203 may generate a delta 205A, e.g., a client delta, representing a collection of changes made to the first image of data model 201.

At Step 302, application 203 may determine whether other new changes to data model 201 have been checked in and saved to repository 202 by another user, e.g., the second user. Repository 202 may notify application 203 if new changes have been checked in and saved to repository 202. If no new changes to data model 201 has been checked in and saved by another user, e.g., NO at Step 302, application 203 may send delta 205A, e.g., the client delta, to repository 202 at Step 303. Repository 202 may receive delta 205A from application 203 and may apply delta 205A to the first image of data model 201 to generate a second image of data model 201, e.g., a server image. Repository 202 may determine whether data model 201 is checked out by another user. If data model 201 is checked out by another user, repository 202 may store delta 205A sent from application 203 after the second image of data model 201 is generated.

After the first user checked delta 205A into repository 202, the second user may finish making changes to data model 201 at application 204 and may check data model 201 back into repository 202. During the check-in process, e.g., the saving process as shown in FIG. 3, application 204 may extract from a transaction log of application 204 all changes made by the second user, which are recorded in the transaction log of application 204. Application 204 may generate a delta 205B representing a collection of changes made to the first image of data model 201.

At Step 302, application 204 may determine whether new changes to data model 201 have been checked in and saved to repository 202 by another user, e.g., the first user. Repository 202 may notify application 204 that delta 205A from the first user has been checked in and saved in repository 202. Because the first user has checked-in and saved changes to data model 201 before the second user, e.g., YES at Step 302, the process may proceed to Step 304. At Step 304, application 204 may request repository 202 to send changes made to data model 201 by the first user. Repository 202 may send delta 205A to application 204, without sending the entire second image of data model 201, which previously was generated from applying delta 205A to the first image of data model 201. Because the data size of delta 205A is less than that of the entire second image of data model 201, the loading process of delta 205A may require less time than when the entire second image of data model 201 is loaded to application 204. Thus, significant delay in the loading process may be prevented.

At Step 305, application 204 may instruct a transaction manager to undo, e.g., roll back, changes made to the first image of data model 201 by the second user at application 204. The first image of data model 201 changed by the second user at application 204 may be rolled back based on the collection of changes recorded in the transaction log of application 204. After the roll-back process, the first image of data model 201 modified by the second user may be restored to the first image of data model 201 initially received from repository 202. At Step 306, application 204 may apply the changes in delta 205A on the restored first image of data model 201. Specifically, application 204 may redo, e.g., roll forward, the changes of delta 205A to the restored first image of data model 201. By redoing changes of delta 205A to the restored first image of data model 201, a copy of the second image of data model 201, e.g., the sever image, stored at repository 202 may be recreated at application 204. Thus, even though the second image of data model 201 is not sent to application 204, the second image of data model 201 may be recreated using delta 205A. At Step 307, application 204 then may mark a location in the transaction log when application 204 completes the recreation of the second image of data model 201 as a save point. The save point may be a reference point in the transaction log from which application 204 may begin collecting the changes to generate a merged delta, as explained below.

At Step 308, application 204 may instruct a scripting engine of application 204 to begin executing changes to the recreated second image of data model 201 using delta 205B, which is a collection of changes previously made by the second user in application 204. The scripting engine may execute the changes of delta 205B serially, e.g., in a chronological order.

When conflicts are detected between the changes made by the second user in delta 205B and the changes made by the first user incorporated in the second image of data model 201, application 204 may notify the second user by displaying a message describing the conflict. Application 204 may allow the second user to choose how the conflict is to be resolved. For example, the second user may choose to discard the changes made by the second user in application 204 and to adopt the changes made by the first user in application 203. In another embodiment, a predetermined user priority may be set, such that the conflicts are resolved in favor of changes made by the user with the higher user priority. In still another embodiment, application 204 may resolve the conflicts based on a history of how the conflicts were resolved previously.

After the scripting engine of application 204 finishes making changes to the second image of data model 201 using delta 205B, application 204 may extract changes stored after the save point in the transaction log to generate the merged delta at Step 309. At Step 310, application 204 may send the merged delta to repository 202. Repository 202 may receive the merged delta and apply the merged delta to the second image of data model 201 to generated a third image of data model 201. Accordingly, the first image of data model 201 at repository 202 may be merged with both delta 205A made by the first user in application 203 and delta 205B made by the second user in application 204.

Repository 202 may store data model 201 as a series of incremental changes, e.g., deltas, to the first image of data model 201. In another embodiment, each version of data model 201 may be stored as independent full images of data model 201. In still another embodiment, repository 202 may store a full image of the latest version of data model 201 and may store older versions of data model 201 as deltas that may be used to revert the latest version of data model 201 to the older versions data model 201. This reverse delta storage approach may improve loading time. In the reverse delta storage approach, after repository 202 receives the merged delta, repository 202 may apply the merged delta to the second image of data model 201 to generate the third image of data model 201. Repository 202 may then invert the merged delta, e.g., rearrange the changes in the merged delta in a reverse chronological order, and may replace the first image of data model 201 with the inverted merged delta.

While the invention has been described connection with various exemplary structures and illustrative embodiments, it will be understood by those skilled in the art that other variations and modifications of the structures and the embodiments described above may be made without departing from the scope of the invention. Other structures and embodiments will be apparent to those skilled in the art from the descriptions of the specification, including the accompanying figures, or from practice of the invention disclosed herein. It is intended that the specification and described examples are illustrative and that the true scope of the invention being defined by the following claims.

1. A method for implementing data model management at a first client application comprising:
receiving, at the first client application, a data model from a repository;
generating a first delta data from changes made by the first client application to the data model;
detecting whether a second delta data, which is generated by a second client application from changes made to the data model at the second client application, is stored in the repository;
sending the generated first delta data to the repository when the second delta data is not stored in the repository;
when the second delta data is stored in the repository:
requesting the second delta data generated by the second client application from the repository;
generating a merged delta data at the first client application by merging the first delta data with the second delta data; and
sending the merged delta data to the repository.

2. The method for implementing data model management according to claim 1, wherein generating the first delta data comprises extracting the changes made to the data model from a transaction log.

3. The method for implementing data model management according to claim 1, wherein the generating the merged delta data comprises:
undoing the changes to the data model made by the first client application;
redoing the changes to the data model made by the second client application based on the second delta data to generate a server image of the data model;
execute changes of the first delta data to the server image of the data model; and
extracting changes made to the server image of the data model from a transaction log to generate the merged delta data.

4. The method for implementing data model management according to claim 3, wherein the executing changes of the first delta data to the server image of the data model comprises:
scripting the first delta data against the server image of the data model;
detecting a conflict between the first delta data and the second delta data incorporated in the server image of the data model; and
resolving the conflict between the first delta data and the second delta data.

5. The method for implementing data model management according to claim 4, wherein the resolving the conflict comprises adopting a change of one of the first delta data and the second delta data in preference to the other one of the first delta data and the second delta data based on a user instruction.

6. The method for implementing data model management according to claim 4, wherein resolving the conflict comprises adopting a change of one of the first delta data and the second delta data in preference to the other one of the first delta data and the second delta data based on a predetermined priority.

7. The method for implementing data model management according to claim 4, wherein resolving the conflict comprises adopting a change of one of the first delta data and the second delta data in preference to the other one of the first delta data and the second delta data based on a prior conflict resolution.

8. A method for implementing data model management at a data model repository comprising:
storing a data model at the data model repository;
sending the data model stored at the data model repository to a first client and a second client;
receiving and storing, at the data model repository, a first delta data generated from changes made by the first client to the data model;
receiving, at the data model repository, a request from the second client for the first delta data;
sending the first delta data generated by the first client from the data model repository to the second client; and
receiving and storing a merged delta data incorporating the first delta data and a second delta data generated by the second client from the second client.

9. The method for implementing data model management according to claim 8, wherein storing the first delta data comprises incorporating the first delta data to the data model to generate a new server image of the data model.

10. The method for implementing data model management according to claim 8 further comprising notifying the second client whether the first delta data from the first client is stored at the data model repository.

11. The method for implementing data model management according to claim 8, wherein storing the data model comprises storing a base image of the data model and a collection of incremental changes to the base image of the data model.

12. The method for implementing data model management according to claim 8, wherein storing the data model comprises storing a plurality of versions of images of the data model.

13. The method for implementing data model management according to claim 8, wherein storing the data model comprises storing an updated image of the data model and a collection of changes arranged in a reversed chronological order.

14. A system for implementing data model management, the system comprising:
a first client terminal having a first client application stored thereon that comprises computer-readable instructions instructing the first client terminal to execute:
receiving the data model from a repository;
generating a first delta data from changes made by the first client application to the data model;
detecting whether a second delta data, which is generated from a second client terminal by making changes to the data model using a second client application implemented on the second client terminal, is stored in the repository;
sending the generated first delta data to the repository when the second delta data is not stored in the repository;
when the second delta data is stored in the repository:
requesting the second delta data generated by the second client application from the repository;
generating a merged delta data by merging the first delta data with the second delta data; and
sending the merged delta data to the repository.

15. The system for implementing data model management according to claim 14 further comprising:
the repository comprising a processor having computer-readable instructions stored thereon instructing the processor to execute:
storing the data model;
sending the data model to the first client application and the second client application;
receiving and storing the first delta data generated from changes made by the first client to the data model;
receiving a request from the second client application for the first delta data;
sending the first delta data generated by the first client application to the second client application; and
receiving and storing the merged delta data incorporating the first delta data and the second delta data generated by the second client application from the second client application.

16. The system for implementing data model management according to claim 14, wherein generating the first delta data comprises extracting the changes made to the data model from a transaction log.

17. The system for implementing data model management according to claim 14, wherein generating the merged delta data comprises:
undoing the changes to the data model made by the first client application;
redoing the changes to the data model made by the second client application based on the second delta data to generate a server image of the data model;
execute changes of the first delta data to the server image of the data model; and
extracting changes made to the server image of the data model from the transaction log to generate the merged delta data.

18. The system for implementing data model management according to claim 17, wherein executing changes of the first delta data to the server image of the data model comprises:
scripting the first delta data against the server image of the data model;
detecting a conflict between the first delta data and the second delta data incorporated in the server image of the data model; and
resolving the conflict between the first delta data and the second delta data.

19. A system for implementing data model management, the system comprising:
a repository comprising a processor having computer-readable instructions stored thereon instructing the processor to execute:
storing a data model;
sending the data model to a first client and a second client;
receiving and storing a first delta data generated from changes made by the first client to the data model;
receiving a request from the second client for the first delta data;
sending the first delta data generated by the first client to the second client; and
receiving and storing a merged delta data incorporating the first delta data and a second delta data generated by the second client from the second client.

20. The system for implementing data model management according to claim 19, wherein storing the first delta data comprises incorporating the first delta data to the data model to generate a new server image of the data model.

21. The system for implementing data model management according to claim 19 further comprising notifying the second client whether the first delta data from the first client is stored at the data model repository.
